(19) United States
(12) Patent Application Publication
(10) Pub. No.: US 2025/0076606 A1
(43) Pub. Date: Mar. 6, 2025

(54) OPTICAL ZOOM LENS MODULE AND HEAD MOUNTED ELECTRONIC DEVICE

(71) Applicant: NEWMAX TECHNOLOGY CO., LTD., Taichung City (TW)

(72) Inventors: Hung-Ta CHEN, Taichung City (TW); Chia-Yu CHANG, Taichung City (TW); Ming-Huang HUANG, Taichung (TW)

(21) Appl. No.: 18/385,371

(22) Filed: Oct. 30, 2023

(30) Foreign Application Priority Data
Aug. 30, 2023 (TW) 112132869

(51) Int. Cl. G02B 7/02

(52) U.S. Cl. CPC G02B 7/021

(57) ABSTRACT

An optical zoom lens module includes: a first lens barrel including a straight groove and a protrusion; a second lens barrel disposed inside the first lens barrel, and including a convex rib; and an operating element disposed outside the first lens barrel, and including an oblique groove and a limiting groove, wherein the oblique groove is stacked on the straight groove in the radial direction, the convex rib passes through the straight groove and is positioned in the oblique groove, and the protrusion is located in the limiting groove; wherein when the operating element is rotated, the oblique groove make the convex rib of the second lens barrel move along the corresponding straight groove and oblique groove, and simultaneously the limiting groove is also moved relative to the protrusion.

This application claims the benefit of Taiwan Patent Application No. 112132869, filed on Aug. 30, 2023, which is hereby incorporated by reference for all purposes as if fully set forth herein.

### BACKGROUND

### Technical Field

The present disclosure relates to an optical zoom lens module, in particular to a head mounted electronic device having an optical zoom lens module.

### Related Art

Virtual Reality (VR) is a computer simulation system capable of creating and experiencing a virtual world and utilizing a computer for generating an interactive analogous environment of the multi-source information fusion to make users immersed in the interactive environment. With constant development of the technology, VR is increasingly applied to industries and fields such as medicine, entertainment, industrial simulation, aerospace and education.

A Head Mounted Device (HMD) serving as one of important devices for realizing VR is gradually popularized in life. The HMD can expand a scientific three-dimensional visualization degree, promotes the interaction performance between a user and a computer, and is increasingly focused by people along with application of VR in many technical fields.

Currently, a head mounted electronic device is used in a glasses-wearing mode or a naked-eye mode, and thus a space for accommodating glasses may be reserved during designing the head mounted electronic device. However, if a myopic user wears glasses and then uses the head mounted electronic device, it is possible to compress the glasses of the user, and consequently discomfort or glasses damage is caused. If the myopic user selects to directly use the head mounted electronic device without wearing the glasses, the user cannot clearly see images or feels uncomfortable due to the problem of focal length, and consequently resists the head mounted electronic device.

Thus, the optical zoom lens module and the head mounted electronic device need to be provided for solving previous problems.

### SUMMARY

An objective of the present disclosure is to provide the optical zoom lens module that can improve the assembly accuracy of the optical zoom lens module, and simultaneously facilitate the user to adjust the focus of the optical zoom lens module; furthermore, the convex rib can be prevented from accidentally leaving the straight groove and the oblique groove, or the convex rib can be prevented from hitting the tail end of the straight groove and the tail end of the oblique groove.

To achieve the above objective, the present disclosure provides an optical zoom lens module having a central axis and a radial direction perpendicular to the central axis, the optical zoom lens module comprising: a first lens barrel surrounding the central axis, and comprising a first barrel body, a straight groove and a protrusion, wherein the straight groove penetrates the first barrel body, and the protrusion is located on an outer annular surface of the first barrel body; a second lens barrel surrounding the central axis, disposed inside the first lens barrel, and comprising a second barrel body and a convex rib, wherein the convex rib is located on an outer annular surface of the second barrel body; and an operating element surrounding the central axis, and disposed outside the first lens barrel, and comprising a ring body, an oblique groove and a limiting groove, wherein the oblique groove and the limiting groove are located on an inner surface of the ring body, the oblique groove and the straight groove are stacked in the radial direction, the convex rib passes through the straight groove and is positioned in the oblique groove, and the protrusion is located in the limiting groove; wherein when the operating element is rotated, the oblique groove causes the convex rib of the second lens barrel to move along the corresponding straight groove and oblique groove, and simultaneously the limiting groove is also moved relative to the protrusion.

The present disclosure further provides a head mounted electronic device, comprising: a shell; the above-mentioned optical zoom lens module disposed in the shell; and a controller disposed in the shell.

According to the optical zoom lens module of the present disclosure, during assembly the operating element is positioned by the protrusion, and the convex rib of the second lens barrel is accurately disposed in the straight groove and the oblique groove, so as to avoid the user's unsmooth feeling when rotating the operating element, and further to improve the assembly accuracy of the optical zoom lens module. Furthermore, when the convex rib of the second lens barrel moves along the corresponding straight groove and the oblique groove, the second lens unit disposed in the second lens barrel is also moves in the direction parallel to the central axial, whereby the imaging position of the optical zoom lens module can be adjusted, and the user easily adjusts the focus of the optical zoom lens module. In addition, while rotating the operating element to move the second lens unit (that is, adjusting the imaging position of the optical zoom lens module), the limiting groove can be also restricted by the protrusion and move within a limited range, thereby restricting the rotation of the operating element within a limited range, and further restricting the movement of the convex rib within a limited range of the straight groove and the oblique groove, so as to prevent the convex rib from accidentally leaving the straight groove and the oblique groove, or prevent the convex rib from hitting the tail end of the straight groove and the tail end of the oblique groove.

### BRIEF DESCRIPTION OF THE DRAWINGS

FIG. 1 is an exploded perspective schematic view of an optical zoom lens module according to an embodiment of the present disclosure.

FIG. 2 is a combined perspective schematic view of an optical zoom lens module according to an embodiment of the present disclosure, showing that a second lens unit of a second lens barrel is moved from a first straight position to a second straight position.

FIG. 3a is a combined sectional schematic view of an optical zoom lens module according to an embodiment of the present disclosure, showing that a convex rib of a second lens barrel is moved from a first straight position to a second straight position.

FIG. 3b is a combined sectional schematic view of an optical zoom lens module according to another embodiment of the present disclosure, showing that a convex rib of a second lens barrel is moved from a first straight position to a second straight position.

FIG. 4 is an exploded perspective schematic view of the first lens barrel, the second lens barrel and the operating element of the optical zoom lens module according to an embodiment of the present disclosure.

FIG. 5 is a partial perspective schematic view of the operating element of the optical zoom lens module according to an embodiment of the present disclosure.

FIG. 6 is a perspective schematic view of the first lens barrel of the optical zoom lens module according to an embodiment of the present disclosure.

FIG. 7 is a three-dimensional schematic view of a head mounted electronic device according to an embodiment of the present disclosure.

### DETAILED DESCRIPTION

To make the foregoing objectives, characteristics and features of the present disclosure more comprehensible, preferred embodiments of the present disclosure are described in detail below with reference to the accompanying drawings.

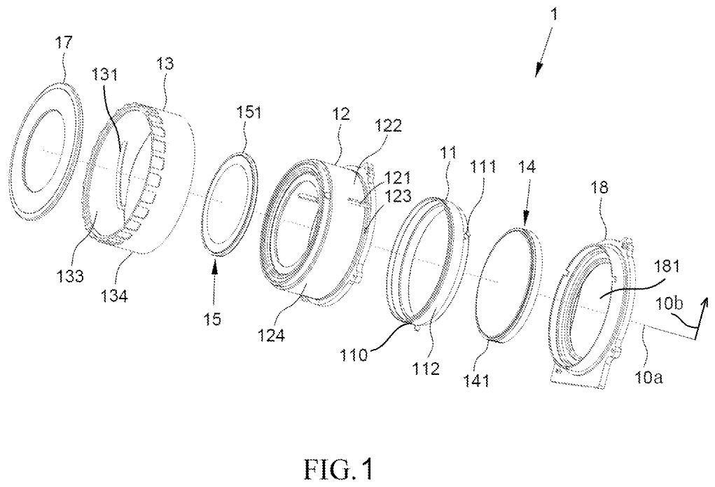

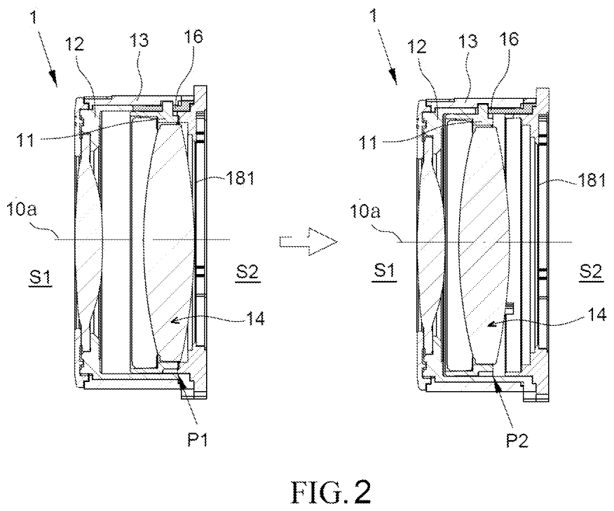

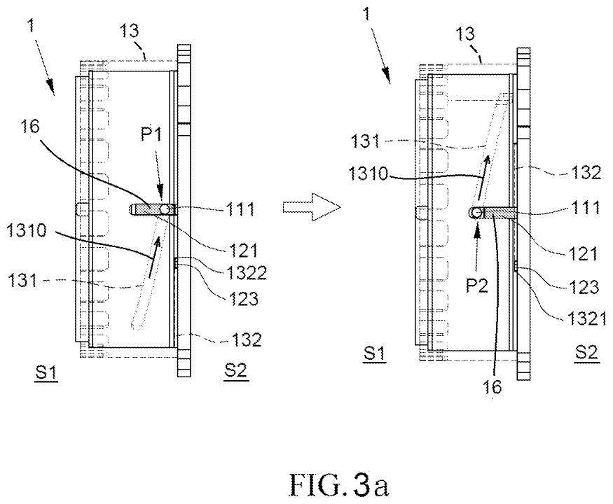

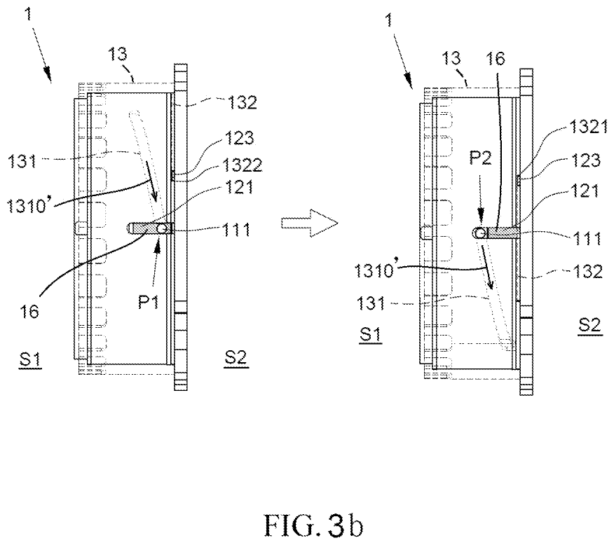

FIG. 1 is an exploded perspective schematic view of an optical zoom lens module according to an embodiment of the present disclosure. FIG. 2 is a combined perspective schematic view of an optical zoom lens module according to an embodiment of the present disclosure, showing that a second lens unit of a second lens barrel is moved from a first straight position to a second straight position. FIG. 3a is a combined sectional schematic view of an optical zoom lens module according to an embodiment of the present disclosure, showing that a convex rib of a second lens barrel is moved from a first straight position to a second straight position. Referring to FIG. 1, FIG. 2 and FIG. 3a, the optical zoom lens module 1 has an eye side S1 and an image source side S2, and includes: a first lens barrel 12, a first lens unit 15, a second lens barrel 11, and a second lens unit 14 and an operating element 13.

The first lens barrel 12 (which can be called a fixed barrel) surrounds the central axis 10a and includes a first barrel body 122, a straight groove 121 and a protrusion 123. A straight direction of the straight groove 121 refers to an extending direction of a groove which is parallel to the central axis 10a. The first lens barrel 12 can be made of plastic material. The straight groove 121 penetrates the first barrel body 122, and the protrusion 123 (which can be called a limiting protrusion) is located on an outer annular surface 124 of the first barrel body 122. The first lens unit 15 is disposed in the first lens barrel 12. The first lens unit 15 includes an optical lens 151. In this embodiment, the total number of the optical lens 151 is one piece, but it is not limited thereto. The optical lens 151 can be made of plastic material or glass material.

The second lens barrel 11 (which can be called a straight barrel) surrounds the central axis 10a and is disposed in the first lens barrel 12. The second lens barrel 11 includes a second barrel body 110 and a convex rib 111. The convex rib 111 is located on an outer annular surface 112 of the second barrel body 110. The second lens barrel 11 can be made of plastic material. The second lens unit 14 is disposed in the second lens barrel 11. The second lens unit 14 includes an optical lens 141. In this embodiment, the total number of the optical lens 141 is one piece, but it is not limited thereto. The optical lens 141 can be made of plastic material or glass material.

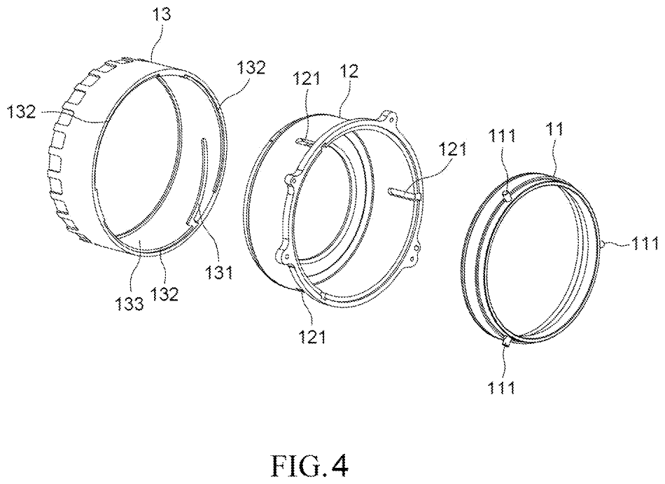

FIG. 4 is an exploded perspective schematic view of the first lens barrel, the second lens barrel and the operating element of the optical zoom lens module according to an embodiment of the present disclosure. Please refer to FIGS. 1, 2, 3a and 4, the operating element 13 (which can be called an operating ring) surrounds the central axis 10a, is disposed outside the first lens barrel 12, and includes a ring body 134, an oblique groove 131 and a limiting groove 132. The operating element 13 can be made of plastic material. The oblique groove 131 and the limiting groove 132 are both located on an inner annular surface 133 of the ring body 134 and do not penetrate the ring body 134, but are not limited thereto. An oblique direction of the oblique groove 131 refers an extending direction 1310 of the oblique groove 131 which has a specific slope along the inner ring surface 133. In this embodiment, the extending direction 1310 of the oblique groove 131 is in the counter-clockwise direction (viewed from the eye side S1). The limiting groove 132 includes a first tail end 1321 and a second tail end 1322 relative to the first tail end 1321, wherein the first tail end 1321 can be adjacent to the oblique groove 131 and communicate with the oblique groove 131, and the second tail end 1322 is a closed end of the limiting groove 132. The oblique groove 131 and the straight groove 121 of the first lens barrel 12 are stacked in the radial direction 10b (which is perpendicular to the central axis 10a). The convex rib 111 passes through the vertical groove 121 and is positioned in the oblique groove 131, and the protrusion 123 is located in the limiting groove 132.

According to the optical focus module 1 of the present disclosure, during assembly, the operating element 13 is positioned by the protrusion 123, and the convex rib 111 of the second lens barrel 11 is accurately disposed in the straight groove 121 and the oblique groove 131, so as to avoid the user's unsmooth feeling when rotating the operating element 13, and further to improve the assembly accuracy of the optical zoom lens module. Furthermore, when the operating element 13 is rotated, the oblique groove 131 causes the convex rib 111 of the second lens barrel 11 to move along the corresponding straight groove 121 and the oblique groove 131, and simultaneously the limiting groove 132 also moves relative to the protrusion 123. When the convex rib 111 of the second lens barrel 11 moves along the corresponding straight groove 121 and the oblique groove 131, the second lens unit 14 disposed in the second lens barrel 11 is also moving in the direction parallel to the central axis 10a, whereby the imaging position of the optical zoom lens module 1 can be adjusted, and the user easily adjusts the focus of the optical zoom lens module 1. In addition, while rotating the operating element 13 to move the second lens unit 14 (that is, adjusting the imaging position of the optical zoom lens module 1), the limiting groove 132 can be also restricted by the protrusion 123 and move within a limited range, thereby restricting the rotation of the operating element 13 within a limited range, and further restricting the movement of the convex rib 111 within a limited range of the straight groove 121 and the oblique groove 131, so as to prevent the convex rib 111 from accidentally leaving the straight groove 121 and the oblique groove 131, or prevent the convex rib 111 from hitting the tail end of the straight groove 121 and the tail end of the oblique groove 131.

In detail, referring to FIG. 2 and FIG. 3a again, the straight groove 121 of the first lens barrel 12 is parallel to the central axis 10a, and includes a first straight position P1 and a second straight position P2 relative the first straight position P1, wherein the first straight position P1 is adjacent to the image source side S2, and the second vertical position P2 is adjacent to the eye side S1. When the operating element 13 is rotated in a rotation direction (for example, the rotation direction is counter-clockwise when viewed from the eye side S1), a force (such as a touch force) of the oblique groove 131 can cause the convex rib 111 of the second lens barrel 11 to move from the first straight position P1 to the second straight position P2 along the corresponding straight groove 121 and the oblique groove 131, and simultaneously the limiting groove 132 is also moved relative to the protrusion 123 so that the protrusion 123 is located a position from being near the first tail end 1321 to being near the second tail end 1322, so as to adjust the imaging position of the optical zoom lens module 1 to the first imaging position. When the operating element 13 is rotated in the other rotation direction (for example, the other rotation direction is clockwise when viewed from the eye side S1), another force (such as a touch force) of the oblique groove 131 can cause the convex rib 111 of the second lens barrel 11 to move from the second straight position P2 to the first straight position P1 along the corresponding straight groove 121 and the oblique groove 131, and simultaneously the sliding groove 132 is also moved relative to the protrusion 123 so that the protrusion 123 is located at a position from being near the second tail end 1322 to being near the first tail end 1321, so as to adjust the imaging position of the optical zoom lens module 1 to the second imaging position.

Referring to FIG. 3b, on the contrary, in another embodiment, the extending direction 1310′ of the oblique groove 131 of the operating element 13 is a clockwise direction (viewed from the eye side S1). When the operating element 13 is rotated in the rotation direction (for example, the rotation direction is clockwise when viewed from the eye side S1), a force (such as a touch force) of the oblique groove 131 can cause the convex rib 111 of the second lens barrel 11 to move from the first straight position P1 to the second straight position P2 along the corresponding straight groove 121 and the oblique groove 131, and simultaneously the limiting groove 132 is also moved relative to the protrusion 123 so that the protrusion 123 is located at a position from being near the first tail end 1321 to being near the second tail end 1322. When the operating element 13 is rotated in another rotation direction (for example, the other rotation direction is counter-clockwise when viewed from the eye side S1), another force (such as a touch force) of the oblique groove 131 can cause the convex rib 111 of the second lens barrel 11 to move from the second straight position P2 to the first straight position P1 along the corresponding straight groove 121 and the oblique groove 131, and simultaneously the limiting groove 132 is also moved relative to the protrusion 123 so that the protrusion 123 is located at a position from being near the second tail end 1322 to being near the first tail end 1321.

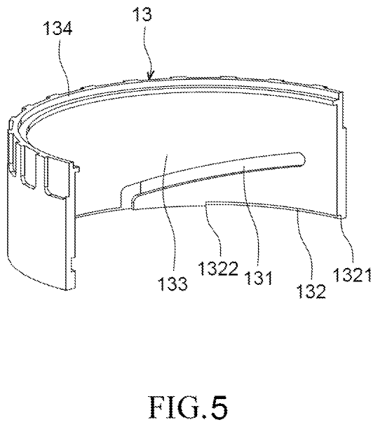

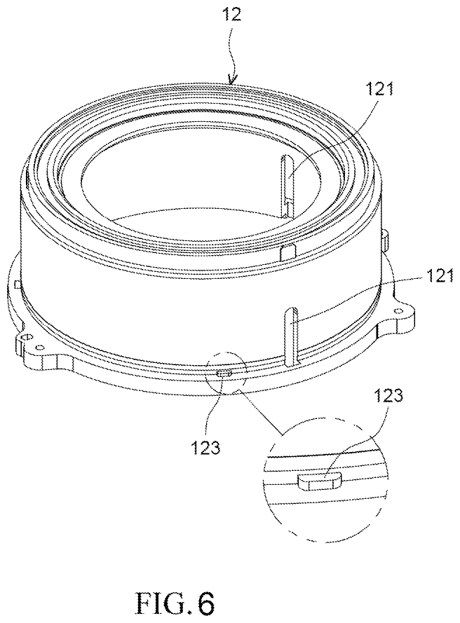

FIG. 5 is a partial perspective schematic view of the operating element of the optical zoom lens module according to an embodiment of the present disclosure. FIG. 6 is a perspective schematic view of the first lens barrel of the optical zoom lens module according to an embodiment of the present disclosure. Referring to FIG. 3a, FIG. 5 and FIG. 6, when the operating element 13 is rotated so that the protrusion 123 touches from the first tail end 1321 to the second tail end 1322 of the limiting groove 132, the operating element 13 performs a maximum rotation angle around the central axis 10a, wherein the maximum rotation angle is between 60-120 degrees according to the zoom and size requirements of the optical zoom lens module 1. For example, when the maximum rotation angle of the optical zoom lens module 1 is designed to be 60 degrees, and the operating element 13 is rotated 60 degrees from the initial position, correspondingly the convex rib 111 of the second lens barrel 11 can be moved from the first straight position P1 to the second straight position P2; for another example, when the maximum rotation angle of the optical zoom lens module 1 is designed to be 120 degrees, and the operating element 13 is rotated 120 degrees from the initial position, correspondingly the convex rib 111 of the second lens barrel 11 can be moved from the first straight position P1 to the second straight position P2.

Referring to FIG. 3a and FIG. 4 again, in this embodiment, the number of the convex rib 111, the number of the straight groove 121, and the number of the oblique groove 131 are three respectively. Since the number of the convex ribs 111, the number of the straight grooves 121 and the number of the oblique grooves 131 are three respectively, each of the convex ribs 111 can be moved more smoothly along the corresponding straight grooves 121 and the corresponding oblique groove 131. The number of the limiting grooves 132 and the number of the protrusions 123 are three respectively. Since the number of the limiting groove 132 and the number of the protrusions 123 are three respectively, each of the limiting grooves 132 can be moved more smoothly relative to the corresponding protrusion 123.

Referring to FIG. 1, FIG. 2 and FIG. 3a again, the optical zoom lens module 1 further includes an image source base 18 and an image source 181 (for example, a liquid crystal display, but is not limited thereto). The image source 181 is located in the image source base 18 and is disposed on a side of the first lens barrel 12 adjacent to the image source side S2. When the operating element 13 is rotated, the oblique groove 131 causes the convex rib 111 of the second lens barrel 11 to move along the corresponding straight groove 121 and the oblique groove 131, so that the second lens unit 14 in the second lens barrel 11 is moved to adjust the distance between the second lens unit 14 and the image source 181, that is, to adjust the imaging position of the optical zoom lens module 1.

Referring to FIG. 2 and FIG. 3a again, the present disclosure can utilize a damping oil 16 disposed between the first lens barrel 12 and the operating element 13; and the damping oil 16 disposed between the convex rib 111 of the second lens 11 barrel and the straight groove 121 of the first lens barrel 12, so that the second lens barrel 11 is moved stably.

Referring to FIG. 1 and FIG. 2 again, the optical zoom lens module 1 further includes an index cover 17, which is disposed on a side of the first lens barrel 12 close to the eye side S1 and can show the rotation scale of the operating element 13, that is, multiple straight positions of the first lens unit 14 (for example, FIG. 2 shows the first straight position P1 and the second straight position P2 of the first lens unit 14, but is not limited thereto), which allows myopic users to quickly operate and use the multiple imaging positions to compensate for myopia.

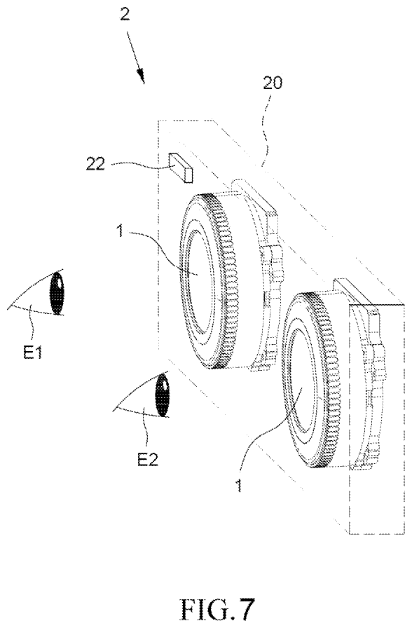

FIG. 7 is a perspective schematic view of a head mounted electronic device according to an embodiment of the present disclosure. The head mounted electronic device 2 includes a shell 20, the above-mentioned optical zoom lens modules 1, and a controller 22. The optical zoom lens module 1 is disposed in the shell 20. The controller 22 is disposed in the shell 20 and electrically connected to the optical zoom lens module 1. The controller 22 may be a general Processor, a Micro Control Unit (MCU), an Application Processor (AP), a Digital Signal Processor (DSP), a Graphics Processing Unit (GPU) or a Holographic Processing Unit (HPU), or any combination of the above processors, and may include various circuit logics for providing a processing and operation function of data and image and transmitting frame data (such as data for representing character messages, graphs or images) to the image source (such as LCD) of each optical zoom lens module 1. In this embodiment, the head mounted electronic device 2 includes two optical zoom lens modules 1 respectively corresponding to a left eye E1 and a right eye E2 so that an imaging distance between the image source 181 and the left eye E1 or the right eye E2 can be independently adjusted, and namely the left eye E1 or the right eye E2 can independently compensate proper myopia degree.

The optical zoom lens module 1 of the present disclosure can be used in a zoom optical system according to the needs, and can be used in various applications such as wearable displays, game consoles, monitor camera lenses, digital cameras, mobile devices, digital tablets, home electronic devices or automotive photography and other electronic imaging systems of 3D (three-dimensional) imaging capture, VR (Virtual Reality) or AR (Augmented Reality).

In view of the above, the foregoing descriptions are merely preferred embodiments of technical means adopted by the present disclosure to solve the problem, but are not intended to limit the scope of the embodiments of the present disclosure. That is, all equivalent changes and modifications made in accordance with the scope of the patent application of the present disclosure or made in accordance with the scope of the patent of the present disclosure fall within the scope of the patent of the present disclosure.

What is claimed is:

1. An optical zoom lens module having a central axis and a radial direction perpendicular to the central axis, the optical zoom lens module comprising:
a first lens barrel surrounding the central axis, and comprising a first barrel body, a straight groove and a protrusion, wherein the straight groove penetrates the first barrel body, and the protrusion is located on an outer annular surface of the first barrel body;
a second lens barrel surrounding the central axis, disposed inside the first lens barrel, and comprising a second barrel body and a convex rib, wherein the convex rib is located on an outer annular surface of the second barrel body; and
an operating element surrounding the central axis, and disposed outside the first lens barrel, and comprising a ring body, an oblique groove and a limiting groove, wherein the oblique groove and the limiting groove are located on an inner surface of the ring body, the oblique groove and the straight groove are stacked in the radial direction, the convex rib passes through the straight groove and is positioned in the oblique groove, and the protrusion is located in the limiting groove;
wherein when the operating element is rotated, the oblique groove causes the convex rib of the second lens barrel to move along the corresponding straight groove and oblique groove, and simultaneously the limiting groove is also moved relative to the protrusion.

2. The optical zoom lens module according to claim 1, wherein the straight groove is parallel to the central axis and comprises a first straight position and a second straight position relative to the first straight position, the first straight position is adjacent to an image source side, the limiting groove comprises a first tail end and a second tail end relative to the first tail end, the first tail end is adjacent to the oblique groove, wherein when the operating element is rotated in a rotation direction, a force of the oblique groove causes the convex rib of the second lens barrel to move from the first straight position to the second straight position along the corresponding straight groove and the oblique groove, and simultaneously the limiting groove is also moved relative to the protrusion so that the protrusion is located at a position from being near the first tail end to being near the second tail end.

3. The optical zoom lens module according to claim 2, wherein when the operating element is rotated in the other rotation direction, another force of the oblique groove causes the convex rib of the second lens barrel to move from the second straight position to the first straight position along the corresponding straight groove and the oblique groove, and simultaneously the limiting groove is also moved relative to the protrusion so that the protrusion is located at a position from being near the second tail end to being near the first tail end.

4. The optical zoom lens module according to claim 2, further comprising a first lens unit disposed in the first lens barrel; and a second lens unit disposed in the second lens barrel.

5. The optical zoom lens module according to claim 4, further comprising an image source disposed a side of the second lens barrel near the image source side, wherein the second lens unit disposed in the second lens barrel is moved from the first straight position to the second straight position, thereby adjusting a distance between the second lens unit and the image source.

6. The optical zoom lens module according to claim 1, wherein the number of the convex ribs is three, the number of the straight grooves is three, the number of the oblique grooves is three, the number of the limiting grooves is three, and the number of the protrusions is three.

7. The optical zoom lens module according to claim 3, wherein when the operating element is rotated so that the protrusion touches from the first tail end to the second tail end of the limiting groove, the operating element performs a maximum rotation angle around the central axis, wherein the maximum rotation angle is between 60-120 degrees.

8. The optical zoom lens module according to claim 1, wherein the oblique groove and the limiting groove do not penetrate the ring body.

9. The optical zoom lens module according to claim 1, further comprising a damping oil disposed between the first lens barrel and the operating element; and the damping oil disposed between the convex rib of the second lens barrel and the straight groove of the first lens barrel.

10. A head mounted electronic device, comprising:
a shell;
an optical zoom lens module disposed in the shell, wherein the optical zoom lens module has a central axis and a radial direction perpendicular to the central axis, and comprises:
a first lens barrel surrounding the central axis, and comprising a first barrel body, a straight groove and a protrusion, wherein the straight groove penetrates the first barrel body, and the protrusion is located on an outer annular surface of the first barrel body;
a second lens barrel surrounding the central axis, disposed inside the first lens barrel, and comprising a second barrel body and a convex rib, wherein the convex rib is located on an outer annular surface of the second barrel body; and
an operating element surrounding the central axis, and disposed outside the first lens barrel, and comprising a ring body, an oblique groove and a limiting groove, wherein the oblique groove and the limiting groove are located on an inner surface of the ring body, the oblique groove and the straight groove are stacked in the radial direction, the rib passes through the straight groove and is positioned in the oblique groove, and the protrusion is located in the limiting groove;
wherein when the operating element is rotated, the oblique groove make the convex rib of the second lens barrel move along the corresponding straight groove and oblique groove, and simultaneously the limiting groove is also moved relative to the protrusion; and
a controller disposed in the shell, and electrically connected to the optical zoom lens module.

11. The head mounted electronic device according to claim 10, wherein the straight groove is parallel to the central axis and comprises a first straight position and a second straight position relative to the first straight position, the first straight position is adjacent to an image source side, the limiting groove comprises a first tail end and a second tail end relative to the first tail end, the first tail end is adjacent to the oblique groove, wherein when the operating element is rotated in a rotation direction, a force of the oblique groove causes the convex rib of the second lens barrel to move from the first straight position to the second straight position along the corresponding straight groove and the oblique groove, and simultaneously the limiting groove is also moved relative to the protrusion so that the protrusion is located at a position from being near the first tail end to being near the second tail end.

12. The head mounted electronic device according to claim 11, wherein when the operating element is rotated in the other rotation direction, another force of the oblique groove causes the convex rib of the second lens barrel to move from the second straight position to the first straight position along the corresponding straight groove and the oblique groove, and simultaneously the limiting groove is also moved relative to the protrusion so that the protrusion is from being near the position of the second tail end to being near the position of the first tail end.

13. The head mounted electronic device according to claim 11, further comprising a first lens unit disposed in the first lens barrel; and a second lens unit disposed in the second lens barrel.

14. The optical zoom lens module according to claim 13, further comprising an image source disposed a side of the second lens barrel near the image source side, wherein the second lens unit disposed in the second lens barrel is moved from the first straight position to the second straight position, thereby adjusting a distance between the second lens unit and the image source.

15. The head mounted electronic device according to claim 10, wherein the number of the convex ribs is three, the number of the straight grooves is three, the number of the oblique grooves is three, the number of the limiting grooves is three, and the number of the protrusions is three.

16. The head mounted electronic device according to claim 12, wherein when the operating element is rotated so that the protrusion touches from the first tail end to the second tail end of the limiting groove, the operating element performs a maximum rotation angle around the central axis, wherein the maximum rotation angle is between 60˜120 degrees.

17. The head mounted electronic device according to claim 10, wherein the oblique groove and the limiting groove do not penetrate the ring body.

18. The head mounted electronic device according to claim 10, further comprising a damping oil disposed between the first lens barrel and the operating component; and the damping oil disposed between the convex rib of the second lens barrel and the straight groove of the first lens barrel.
